(19) United States
(12) Patent Application Publication
(10) Pub. No.: US 2001/0044755 A1
(43) Pub. Date: Nov. 22, 2001

(54) Trial purchase system and customer information gathering system

(76) Inventor: Hideyuki Sakamoto, Tokyo (JP)

Correspondence Address: McGuireWoods, Suite 1800, 1750 Tysons Boulevard, Tysons Corner, McLean, VA, 22102-4215, US

(21) Appl. No.: 09/872,522

(22) Filed: Jun. 4, 2001

(30) Foreign Application Priority Data
May 6, 2000 (JP) 2000-167670

(51) Int. Cl. G06F 17/60

(52) U.S. Cl. 705/26

(57) ABSTRACT

Commodity providing means for providing commodities or the like in online shopping provides a plurality of terminals with information on commodities for trial purchase, and when a commodity for trial purchase is specified on a terminal, the commodity is provided to a destination designated on the terminal. In this manner, a user can experience a commodity purchase procedure in online shopping by using the information on commodities for trial purchase provided from the commodity providing means.

### BACKGROUND OF THE INVENTION

1. Field of the Invention

The present invention relates to online shopping for selling commodities and the like through a network such as the Internet, and more particularly to a trial purchase system and a method thereof for allowing a user to experience online shopping and a customer information gathering system and a method thereof for gathering information on users as customer information over the network.

2. Description of the Related Art

In these days, the Internet and personal computers are becoming prevalent rapidly to allow individuals to easily connect to the Internet regardless of time or places. With the trend, a sharp increase is seen in the number of companies, organizations and the like which set up and use their home pages on the Internet to provide information or sell commodities and the like.

In the sale of commodities and the like using home pages, that is, so-called online shopping, commodities, services or the like can be easily purchased in homes or the like. Thus, the number of users thereof tends to be increased.

When a user attempts to purchase commodities or the like in typical online shopping for the first time, the user first selects a desired commodity or service from among commodities or services displayed on a terminal such as a personal computer and decides to purchase it. Then, the user enters, as customer information, information on the user such as the name, address, telephone number, e-mail address of the user and selects a payment method.

After the user confirms the commodity to be purchased, the payment method, and the contents of the customer information determined in the aforementioned manner, the commodity or the like is ordered.

In the aforementioned online shopping, a company or the like serving as a provider of commodities or the like transmits to the terminal of the user through a network a page for entering customer information including the name, address, telephone number, e-mail address and the like of the user, a page for selecting a payment method, and a page for the user to confirm the determined commodity to be purchased, the payment method, and the contents of the customer information. The user may enter the aforementioned information into the terminal.

Since it is expected that the utilization of such online shopping will grow in the future, easier and securer online shopping is desired.

Companies or the like serving as providers of commodities or the like gather and analyze information on as many users as possible as customer information to provide information or services appropriate for the users, as a strategy to make a profit. Customer information is also gathered through the aforementioned online shopping.

The aforementioned online shopping involves a purchase procedure different from that in actual purchase of commodities or the like in physical stores and the like. A first-time user is somewhat afraid and unwilling to purchase commodities or the like and cannot decide to purchase commodities as in actual purchase of commodities in stores and the like.

Particularly, since the online shopping requires money, a user cannot decide to utilize it sometimes for fear that the user performs erroneous operations on a terminal to end up paying for a commodity but not receiving it.

In addition, a user cannot decide to utilize the online shopping sometimes since the user does not know how a commodity or the like can be changed in each step, whether a change in a certain step can be made if the user wants the change, or whether the change, if possible, can be made at no charge.

In this manner, since a number of barriers as described above exist to the first-time use of the online shopping, anyone does not necessarily decide to utilize it without hesitation, thereby causing a problem of obstructing the promotion of commodity selling and customer information gathering in the online shopping.

### SUMMARY OF THE INVENTION

It is an object of the present invention to provide a trial purchase system and a method thereof which can further promote the utilization of online shopping, and a customer information gathering system and a method thereof.

In the present invention, commodity providing means for providing commodities or the like in online shopping provides a plurality of terminals with information on commodities for trial purchase, and when a commodity for trial purchase is specified on a terminal, the commodity is provided to a destination designated on the terminal.

In this manner, a user can experience a commodity purchase procedure in the online shopping by using the information on commodities for trial purchase provided from the commodity providing means. Thus, the user does not feel anxiety or unwillingness due to ignorance of how to utilize the online shopping when the user actually utilizes it.

In addition, customer information can be gathered by prompting a user to enter customer information on the user into a terminal when trial purchase is performed.

The above and other object, features, and advantages of the present invention will become apparent from the following description based on the accompanying drawings which illustrate examples of preferred embodiments of the present invention.

### BRIEF DESCRIPTION OF THE DRAWINGS

FIG. 1 is a diagram illustrating an embodiment of a network system in which a trial purchase system of the present invention is incorporated;

FIGS. 2 to 6 are flow charts for describing a trial purchase method and a customer information gathering method in the network system shown in FIG. 1; and

FIG. 7 is a flow chart for describing a process when a user checks the shipping status of a commodity in the network system shown in FIG. 1.

### DETAILED DESCRIPTION OF THE PREFERRED EMBODIMENT

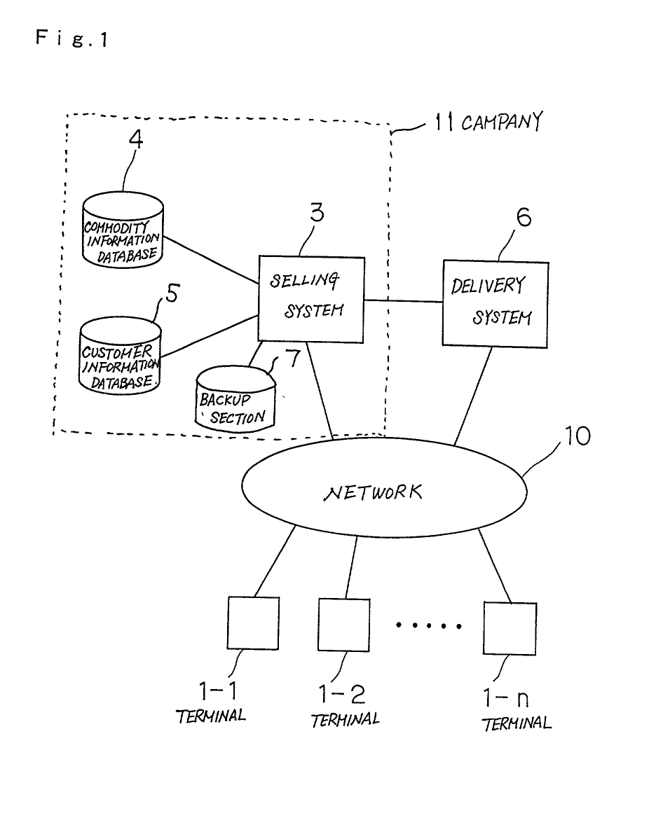

A preferred embodiment of the present invention comprises, as shown in FIG. 1, a plurality of terminals 1-1 to 1-n which are operated by users and are information processing devices such as personal computers, selling system 3 which is held by company 11 as commodity providing means or information gathering means serving as a provider of commodities or services and provides online shopping for terminals 1-1 to 1-n through network 10, commodity information database 4 as commodity information storing means for storing information on commodities dealt in for the online shopping, customer information database 5 as customer information storing means for storing customer information including names, addresses, telephone numbers, e-mail addresses and the like of users, and delivery system 6 for managing arrangements, adjustments, and shipment associated with delivery of commodities or the like in accordance with the instructions from selling system 3. Delivery system 6 may be provided in company 11 or the like serving as the commodity providing means.

Each of terminals 1-1 to 1-n has the function of accessing commodity information and the like provided from selling system 3 over network 10 to display the commodity information and the like on its screen. In addition, terminals 1-1 to 1-n each have the function of transmitting information entered into terminals 1-1 to 1-n by users in accordance with the screen display to selling system 3 through network 10, thereby making it possible to order commodities through a purchase process in the online shopping.

Selling system 3 comprises an information processing device such as a workstation serve or a storage, and has a Web management function, a shop function, an order management and customer management function, and an order receipt, arrangement, adjustment, delivery instruction function. Specifically, selling system 3 provides information on commodities stored in commodity information database 4 for terminals 1-1 to 1-n through network 10. Selling system 3 also receives information entered into terminals 1-1 to 1-n by users through network 10, and based on the received information, transmits order receipt, arrangement, adjustment, delivery instructions and the like of commodities to delivery system 6. In addition, selling system 3 has the functions of storing customer information entered into terminals 1-1 to 1-n by users in customer information database 5, checking whether customer information is stored in customer information database 5, and if it is stored, acquiring the customer information from customer information database 5.

Delivery system 6 comprises an information processing device such as a workstation server or a storage and has the functions of receiving order receipt information from selling system 3 and managing shipment of commodities from arrangements thereof to delivery to designated destinations.

It is also contemplated that company 11 is provided with backup section 7 for holding the functions of selling system 3, the information accumulated in selling system 3, the commodity information stored in commodity information database 4, and the customer information stored in customer information database 5.

In the network system configured as above, selling system 3 provides terminals 1-1 to 1-n with online shopping for virtual experience through network 10 to allow users to experience a commodity purchase procedure in the online shopping through terminals 1-1 to 1-n.

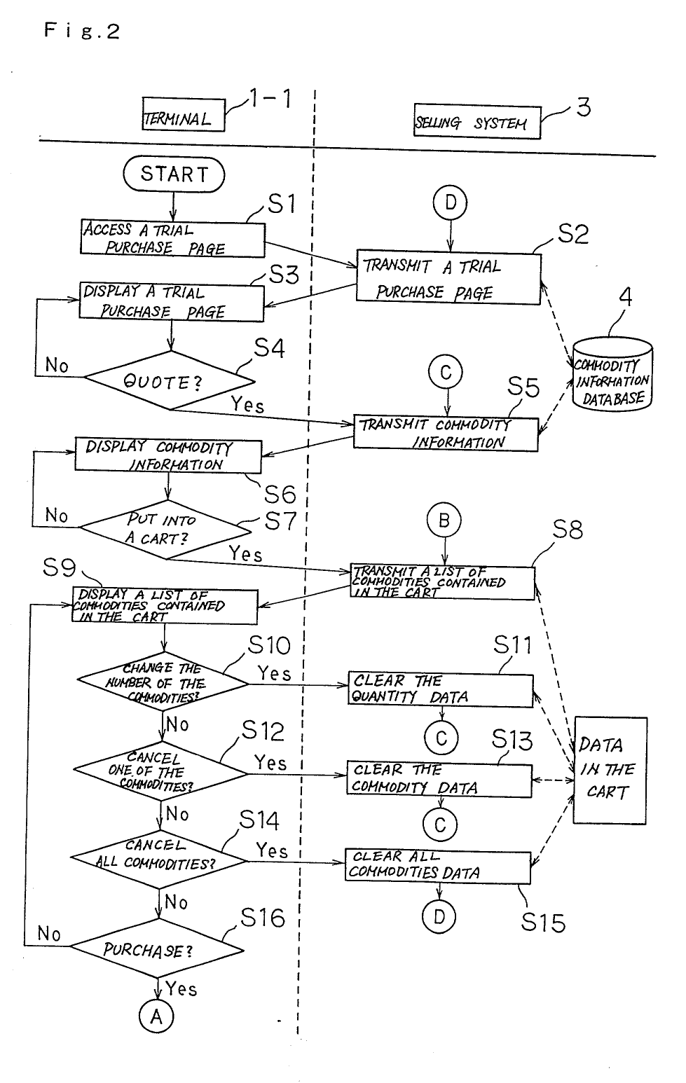

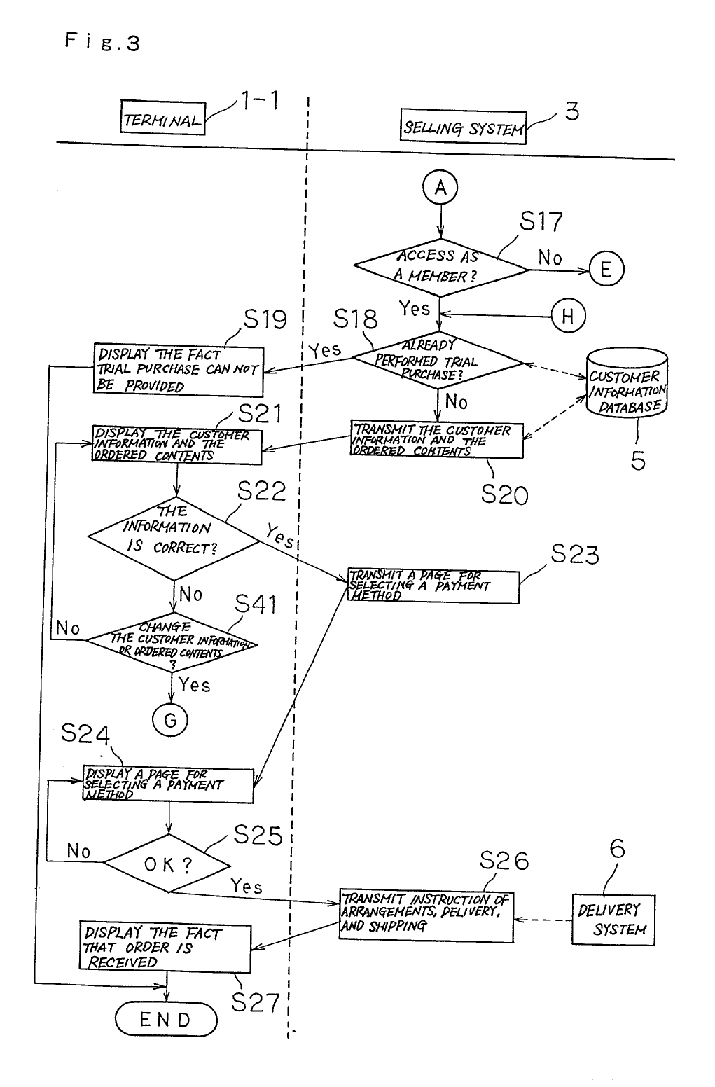

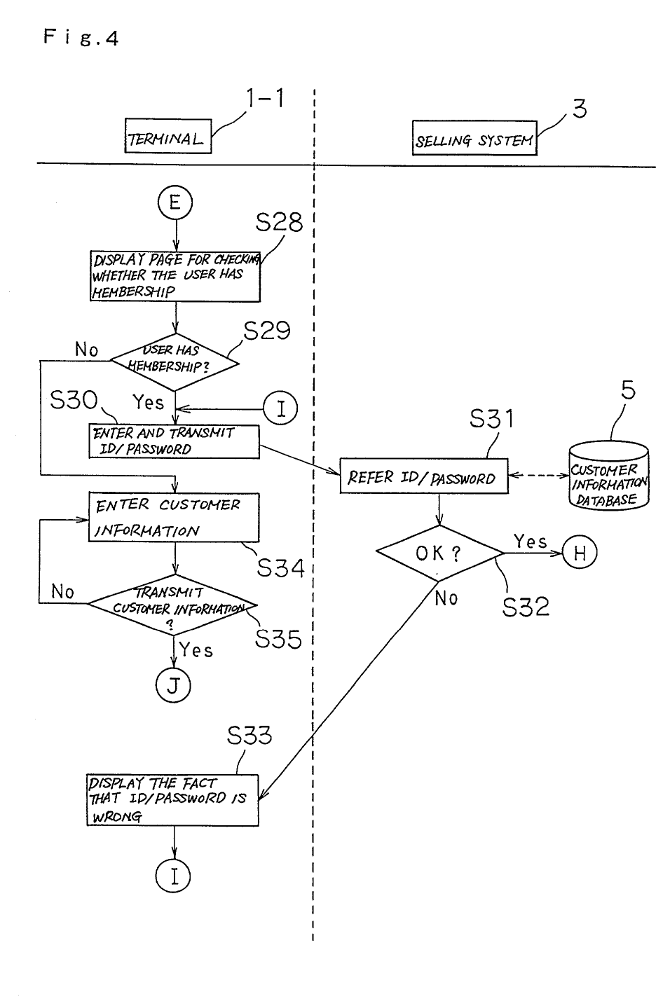

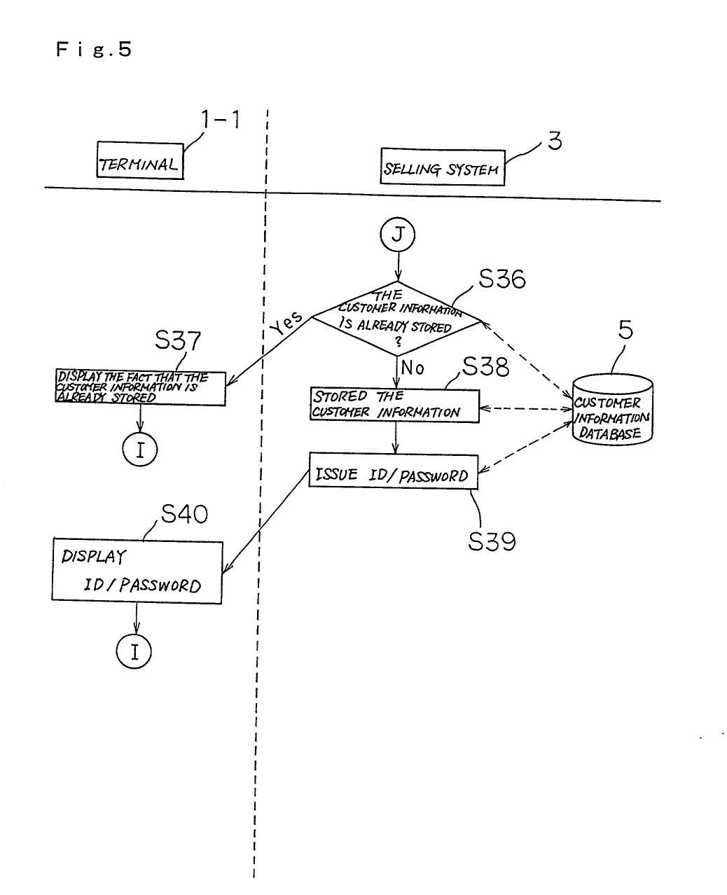

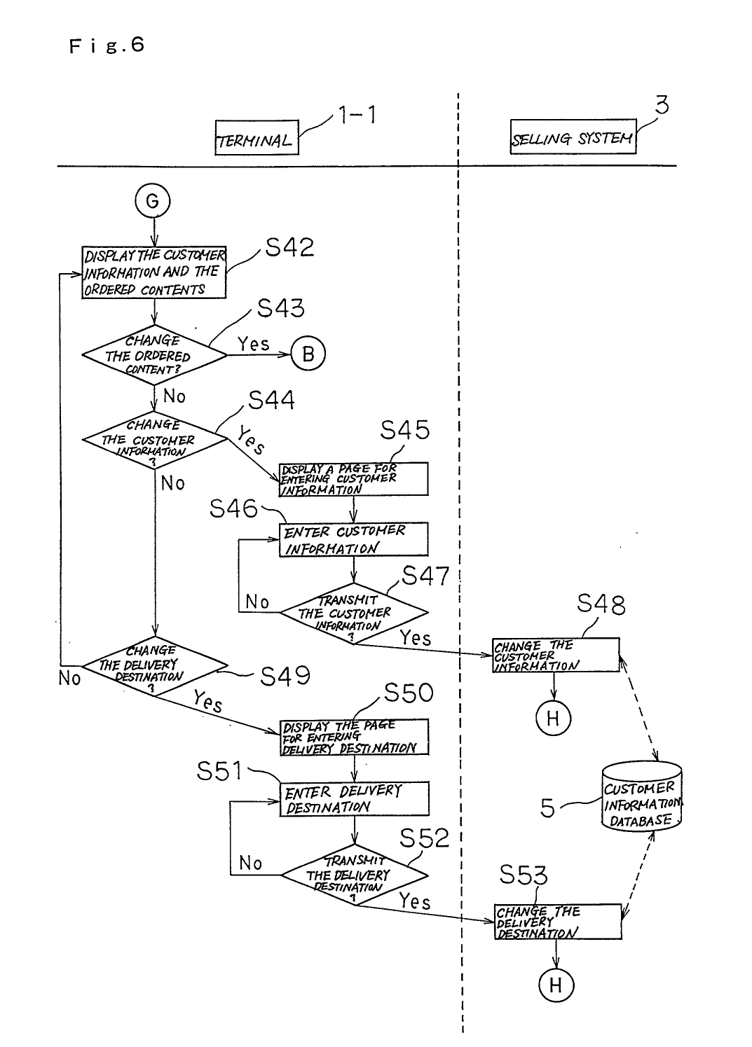

Description is hereinafter made for a trial purchase method and a customer information gathering method with reference to FIGS. 2 to 6 in the network system configured as described above in an example where a user experiences the online shopping on terminal 1-1 and customer information is gathered from terminal 1-1.

A trial purchase process in the embodiment is substantially the same as a typical commodity purchase process except that commodities are limited to commodities for trial purchase (present items or the like) with no base price, no carriage, no consumption tax or the like, and thus the setting of a payment method is not performed. In typical online shopping, payments by a credit card, transfer into an account, cash on delivery and the like are set as possible payment methods. In the trial purchase, however, no payment is required and a user cannot make a selection on a page for selecting one of the payment methods, if displayed. The commodities are not always free of charge, and a predetermined sum of money may be set. In this case, a payment method may be selected. The quantity of commodities to be purchased and the number of purchases may be limited.

A user accesses a trial purchase page provided on network 10 from selling system 3 by using terminal 1-1 in step S1. Then, selling system 3 acquires commodity information for trial purchase from the commodity information stored in commodity information database 4 and produces and transmits a trial purchase page to terminal 1-1 in step S2.

The trial purchase page transmitted from selling system 3 is displayed on terminal 1-1 step S3.

When the user sees the trial purchase page displayed on terminal 1-1 and finds a desired commodity displayed thereon, the users selects the commodity and presses a quotation button in step S4. Then, selling system 3 acquires and transmits cost information on the base price, carriage, consumption tax and the like of the commodity and other information on the commodity from commodity information database 4 to terminal 1-1 in step S5. In step S4, when a plurality of commodities for trial purchase are present, a user may select more than one desired commodity from the plurality of commodities. In the case, selling system 3 acquires and transmits information on each of the more than one commodity selected by the user from commodity information database 4 to terminal 1-1. It is also contemplated that since this is trial purchase, the quantity of commodities selectable by a user is limited to one even when a plurality of commodities are present for trial purchase.

The commodity information transmitted from selling system 3 is displayed on terminal 1-1 in step S6. The information on the commodities for trial purchase is stored in commodity information database 4 with the attributes of all their base prices, carriages, and consumption taxes set to zero.

When the user sees the commodity information displayed on terminal 1-1 and wishes to put a desired commodity into a cart, the user presses a cart button for the commodity in step S7. In response thereto, selling system 3 puts the desired commodity into the cart managed at this point as held by the customer, and transmits to terminal 1-1 a list of commodities contained in the cart in which the commodity is put in step S8. The commodity list transmitted from selling system 3 is displayed on terminal 1-1 in step S9. In step S7, if the user desires more than one commodity, all the desired commodities are put into the cart by pressing a cart button for each desired commodity and a commodity list based thereon is transmitted to terminal 1-1. While the quantity of a desired commodity can be entered when the commodity is put into the cart, it is possible that the number which can be entered is limited to one or lower and another number cannot be set since this is trial purchase.

When the user sees the commodity list displayed on terminal 1-1 and wishes to change the number of the commodities set in step S7, the user presses a quantity change button for the commodity which the user wishes to change on the page displayed on terminal 1-1 in step S10. Then, selling system 3 erases the quantity data on the commodity from the cart managed as held by the user in step S11 and the procedure returns to the processing in step S5.

When the user sees the commodity list displayed on terminal 1-1 and wishes to cancel a desired one of the commodities set in step S7, the user presses a content cancel button for the commodity which the user wishes to cancel on the page displayed on terminal 1-1 in step S12. Then, selling system 3 erases the data on the commodity from the cart managed as held by the user in step S13, and the procedure returns to the processing in step S5.

When the user sees the commodity list displayed on terminal 1-1 and wishes to cancel all the commodities set in step S7, the user presses a cart cancel button on the screen of terminal 1-1 in step S14. Then, selling system 3 erases all the data on the commodities put in the cart managed as held by the user in step S15, and the procedure returns to the processing in step S2.

When the user sees the commodity list displayed on terminal 1-1 and wishes to purchase the commodity set in step S7, the user presses a purchase button on page displayed on terminal 1-1 in step S16. Then, selling system 3 determines whether the user is making access as a member (whether the user is making access using hits ID/password) in step S17. It is possible that a commodity/service provider such as a company does not provide a trial purchase service for members since the provider already acquires customer information on the members and the trial purchase service does not result in acquisition of new customer information. In the embodiment, however, the trial purchase service is provided for a customer with membership.

If the user is making access as a member, selling system 3 determines whether the user has already performed trial purchase based on the customer information stored in customer information database 5 in step S18.

If the user has already performed trial purchase, the embodiment does not provide a trial purchase service two or more times, and thus selling system 3 displays that fact on the screen of terminal 1-1 in step S19 to terminate the process of trial purchase. The procedure may subsequently move to steps for online shopping of general commodities. Alternatively, the trial purchase service may be provided twice or more.

If the user has not received a trial purchase service, selling system 3 acquires customer information including the name, address, telephone number, e-mail address, and the delivery destination in the preceding purchase of the user from customer information database 5 and transmits the acquired information to terminal 1-1 in step S20.

The customer information transmitted from selling system 3 is displayed on the screen of terminal 1-1 together with the ordered contents in step S21. The user checks whether the correct customer information and ordered contents are displayed on the screen of terminal 1-1 in step S22.

If the correct customer information and ordered contents are displayed in step S22, the user presses a confirmation button on the page displayed on terminal 1-1. Then, a page for selecting a payment method is transmitted from selling system 3 in step S23 and displayed on the screen of terminal 1-1 in step S24.

The user otherwise would select one of payment methods displayed on the screen of terminal 1-1. In the embodiment, the payment page is displayed on the screen of terminal 1-1 but no selection can be made since this is trial purchase and the commodities are free of charge.

Then, when the user presses a payment confirmation button in step S25, the information is transmitted to selling system 3. Selling system 3 formally receives the order and transmits instructions of arrangements, delivery, and shipping of the commodity to delivery system 6 in step S26. In selling system 3, the name of the commodity for trial purchase ordered by the user may be stored in customer information database 5 in correspondence with the customer information of the user.

The fact that the order is received without fail, a page for showing appreciation, and the status of the commodity (an order receipt status in this case) are displayed on terminal 1-1, and the trial purchase service is terminated. The procedure may continue to steps for online shopping of general commodities.

On the other hand, if the user is not making access as a member in step S17, selling system 3 displays a page for checking whether the user has membership on terminal 1-1 in step S28 and prompts the user to select whether the user has membership in step S29.

If the user has membership, selling system 3 prompts the user to enter his ID/password in step S30 and refers to the customer information stored in customer information database 5 to make a comparison between the entered and stored ID/passwords in step S31.

If the ID/passwords do not match in step S32, selling system 3 displays the fact that the ID/password is wrong on the screen of terminal 1-1 in step S33 and the procedure returns to the processing in step S30.

If the ID/passwords match, the procedure moves to the processing in step S18 as in a case where the user is making access as a member since the user can be recognized as a member.

If the user is not making access as a member and the user does not have membership, the commodity cannot be delivered since customer information such as the name and address of the user is not stored in customer information database 5. Thus, the user is prompted to enter customer information in step S34. At this point, the user may or may not register himself as a member. In the embodiment, the user is caused to register himself as a member when the user does not have membership at this point.

The user enters his customer information and ID/password into terminal 1-1 and transmits them to selling system 3 in step S35. Then, selling system 3 determines whether the customer information transmitted from terminal 1-1 is new or already stored information in customer information database 5 in step S36.

If the customer information is already stored, selling system 3 displays that fact on the screen of terminal 1-1 in step S37, and the procedure returns to the processing in step S30.

If the customer information is not stored in customer information database 5, selling system 3 stores the customer information on the new member in customer information database 5 in step S38, issues an ID/password in step S39, and provides the issued ID/password to terminal 1-1 in step S40, and then the procedure returns to the processing in step S30.

If any error is found in the customer information or ordered contents in step S22 and a change is made in step S41, selling system 3 displays a page for selecting contents to be changed on terminal 1-1 in step S42.

If the user changes the ordered contents in step S43, the user presses an order content change button on the page displayed on terminal 1-1. The procedure then returns to the processing in step S9 to allow a change in the quantity, contents of the commodity, or the entire cart.

If the user changes the customer information in step S44, the user presses a customer information change button on the page displayed on terminal of 1-1. Then, a page for entering customer information is displayed on terminal 1-1 in step S45.

When the user enters customer information into terminal 1-1 in step S46 and transmits the information to selling system 3 in step S47, selling system 3 changes the customer information stored in customer information database 5 in step S48, and then the procedure moves to the processing in step S18. The customer information change page displays first the information in the last processing to allow the user to change only the portion to be changed.

If the delivery destination of the commodity is changed in step S49, the user presses a delivery destination change button on the page displayed on terminal 1-1. A page for entering a delivery destination is displayed on terminal 1-1 in step S50.

After the user enters a delivery destination into terminal 1-1 in step S51 and transmits it to selling system 3 in step S52, selling system 3 changes the delivery destination stored in customer information database 5 in step S53, and then the procedure moves to the processing in step S18. The delivery destination change page displays first the information in the last processing to allow the user to change only the portion to be changed.

The customer information is not limited to the name, address, telephone number, e-mail address and the like of the user which are entered and stored when the commodity is ordered. It is possible that questionnaires are conducted on a commodity purchase page and the answers to the questionnaires are included in the customer information. In this case, preference information or the like of users can be obtained by the questionnaires and used to provide information or services appropriate for the users.

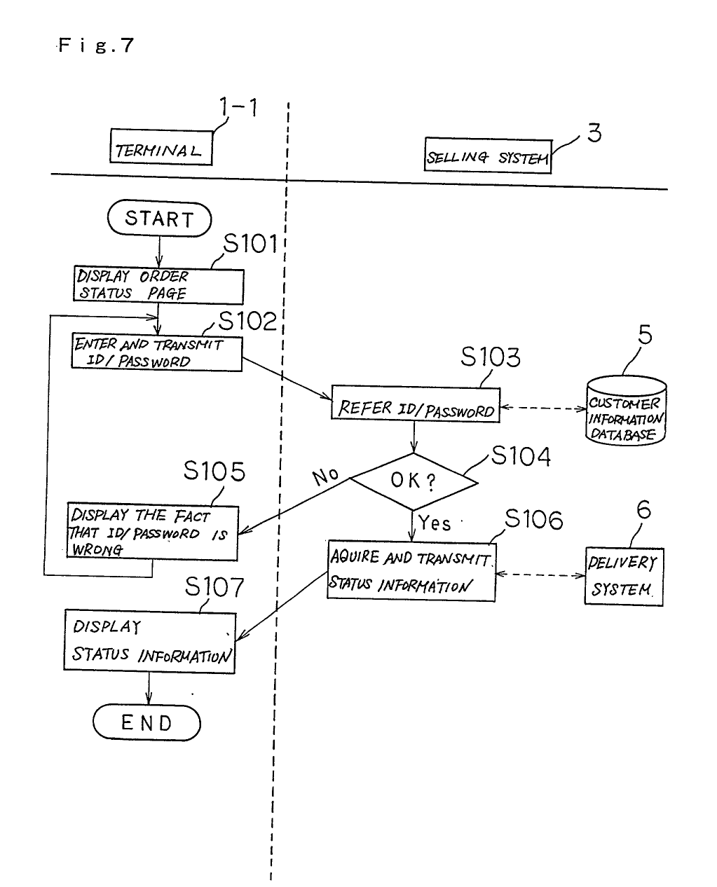

Next, description is made for a process in checking the shipping status of an ordered commodity by a user with reference to FIG. 7.

When a user enters his ID/password on an order status page displayed on the screen of terminal 1-1 in step S101 and transmits the ID/password to selling system 3 in step S102, selling system 3 makes a comparison between the transmitted ID/password and an ID/password in customer information stored in customer information database 5 in step S103. If the ID/password does not match the one stored in customer information database 5 in step S104, that fact is displayed on the screen of terminal 1-1 in step S105, and then the procedure returns to the processing in step S102.

If the ID/password matches the one stored in customer information database 5 in step S104, selling system 3 acquires status information of a commodity ordered by the user from delivery system 6 in step S106, and displays the contents on the screen of terminal 1-1 in step S107. Order tracking similar to that for a normal commodity can also be performed for a trial purchase commodity.

As described above, in the present invention, the commodity information for trial purchase provided by the commodity providing means is used to allow a user to experience the commodity purchase procedure in the online shopping. Thus, the user does not feel anxiety or unwillingness due to ignorance of how to utilize the online shopping when the user actually utilizes the online shopping, thereby allowing further promotion of the utilization of the online shopping. For this reason, promotion of commodity selling or customer information gathering can be achieved.

While preferred embodiments of the present invention have been described using specific terms, such description is for illustrative purposes only, and it is to be understood that changes and variations may be made without departing from the spirit or scope of the following claims.

What is claimed is:

1. A method of trial purchase for allowing users of a plurality of terminals connected to commodity providing means through a network to experience a purchase procedure of a commodity provided from said commodity providing means through said network, said method comprising the steps of:
displaying information on a commodity provided from said commodity providing means for trial purchase on said terminal; and
performing said purchase procedure for trial purchase by the user using said terminal.

2. The method of trial purchase according to claim 1, further comprising the steps of:
previously storing a destination of said commodity for trial purchase; and
providing said commodity for trial purchase to said previously stored destination when said commodity for trial purchase is specified on said terminal.

3. The method of trial purchase according to claim 1, further comprising the steps of:
previously storing a destination of said commodity for trial purchase;
displaying said previously stored destination on said terminal when said commodity for trial purchase is specified on said terminal; and
designating said previously stored destination or a newly designated destination as a destination of said commodity.

4. The method of trial purchase according to claim 3, further comprising the step of storing said newly designated destination.

5. The method of trial purchase according to claim 1, wherein said commodity for trial purchase is free of charge.

6. The method of trial purchase according to claim 2, wherein said commodity for trial purchase is free of charge.

7. The method of trial purchase according to claim 3, wherein said commodity for trial purchase is free of charge.

8. The method of trial purchase according to claim 4, wherein said commodity for trial purchase is free of charge.

9. A trial purchase system comprising:
a plurality of terminals; and
commodity providing means connected to said plurality of terminals through a network for displaying information on a commodity for trial purchase on said terminal and providing said commodity for trial purchase to a destination designated on said terminal when said commodity for trial purchase is specified on said terminal.

10. The trial purchase system according to claim 9, wherein said commodity providing means includes means for previously storing said destination and providing said commodity for trial purchase to said previously stored destination when said commodity for trial purchase is specified on said terminal.

11. The trial purchase system according to claim 9, wherein said commodity providing means includes means for previously storing said destination and providing said commodity for trial purchase to a newly designated destination when said commodity for trial purchase is specified on said terminal and said new destination is designated therefor.

12. The trial purchase system according to claim 11, wherein said commodity providing means includes means for storing said newly designated destination.

13. The trial purchase system according to claim 10, further comprising customer information storing means for storing information on said destinations.

14. The trial purchase system according to claim 11, further comprising customer information storing means for storing information on said destinations.

15. The trial purchase system according to claim 12, further comprising customer information storing means for storing information on said destinations.

16. The trial purchase system according to claim 9, further comprising commodity information storing means for storing information on said commodity.

17. The trial purchase system according to claim 10, further comprising commodity information storing means for storing information on said commodity.

18. The trial purchase system according to claim 11, further comprising commodity information storing means for storing information on said commodity.

19. The trial purchase system according to claim 12, further comprising commodity information storing means for storing information on said commodity.

20. The trial purchase system according to claim 13, further comprising commodity information storing means for storing information on said commodity.

21. The trial purchase system according to claim 14, further comprising commodity information storing means for storing information on said commodity.

22. The trial purchase system according to claim 15, further comprising commodity information storing means for storing information on said commodity.

23. Backup means for use in the trial purchase system according to claim 13, said backup means comprising means for holding the information on the destinations stored in said customer information storing means.

24. Backup means for use in the trial purchase system according to claim 14, said backup means comprising means for holding the information on the destinations stored in said customer information storing means.

25. Backup means for use in the trial purchase system according to claim 15, said backup means comprising means for holding the information on the destinations stored in said customer information storing means.

26. Backup means for use in the trial purchase system according to claim 16, said backup means comprising means for holding the commodity information stored in said commodity information storing means.

27. Backup means for use in the trial purchase system according to claim 17, said backup means comprising means for holding the commodity information stored in said commodity information storing means.

28. Backup means for use in the trial purchase system according to claim 18, said backup means comprising means for holding the commodity information stored in said commodity information storing means.

29. Backup means for use in the trial purchase system according to claim 19, said backup means comprising means for holding the commodity information stored in said commodity information storing means.

30. Backup means for use in the trial purchase system according to claim 20, said backup means comprising means for holding the commodity information stored in said commodity information storing means.

31. Backup means for use in the trial purchase system according to claim 21, said backup means comprising means for holding the commodity information stored in said commodity information storing means.

32. Backup means for use in the trial purchase system according to claim 22, said backup means comprising means for holding the commodity information stored in said commodity information storing means.

33. The trial purchase system according to claim 9, wherein said commodity providing means includes means for providing said commodity for trial purchase at no charge.

34. A method of gathering customer information on users of a plurality of terminals from said terminals connected to a network, said method comprising the steps of:
providing said terminal with information on a commodity for trial purchase to allow experience of a procedure of commodity purchase through said network; and
causing entry of customer information on a user who makes an order for a commodity based on said commodity information into said terminal when said order is received.

35. The method of gathering customer information according to claim 34, wherein said customer information is previously stored and said previously stored customer information is changeable when said commodity for trial purchase is ordered on said terminal.

36. The method of gathering customer information according to claim 35, further comprising the step of storing the name of said commodity for trial purchase in correspondence with the customer information of said user who ordered said commodity.

37. The method of gathering customer information according to claim 34, wherein said commodity for trial purchase is free of charge.

38. The method of gathering customer information according to claim 35, wherein said commodity for trial purchase is free of charge.

39. The method of gathering customer information according to claim 36, wherein said commodity for trial purchase is free of charge.

40. A customer information gathering system comprising:
a plurality of terminals; and
information gathering means connected to said plurality of terminals through a network for providing said terminal with information on a commodity for trial purchase to allow experience of a procedure of commodity purchase through said network and requiring entry of customer information on a user who makes an order for a commodity based on said commodity information when said order is received.

41. The customer information gathering system according to claim 40, wherein said information gathering means includes means for previously storing said customer information and allowing a change in said previously stored customer information when said commodity for trial purchase is ordered on said terminal.

42. The customer information gathering system according to claim 41, wherein said information gathering means includes means for storing the name of said commodity for trial purchase in correspondence with the customer information of said user who ordered said commodity.

43. The customer information gathering system according to claim 41, further comprising customer information storing means for storing said customer information.

44. The customer information gathering system according to claim 42, further comprising customer information storing means for storing said customer information.

45. The customer information gathering system according to claim 40, further comprising commodity information storing means for storing said information on said commodity.

46. The customer information gathering system according to claim 42, further comprising commodity information storing means for storing said information on said commodity.

47. The customer information gathering system according to claim 43, further comprising commodity information storing means for storing said information on said commodity.

48. The customer information gathering system according to claim 44, further comprising commodity information storing means for storing said information on said commodity.

49. Backup means for use in the customer information gathering system according to claim 43, said backup means comprising means for holding said customer information stored in said customer information storing means.

50. Backup means for use in the customer information gathering system according to claim 44, said backup means comprising means for holding said customer information stored in said customer information storing means.

51. Backup means for use in the customer information gathering system according to claim 45, said backup means comprising means for holding said commodity information stored in said commodity information storing means.

52. Backup means for use in the customer information gathering system according to claim 46, said backup means comprising means for holding said commodity information stored in said commodity information storing means.

53. Backup means for use in the customer information gathering system according to claim 47, said backup means comprising means for holding said commodity information stored in said commodity information storing means.

54. Backup means for use in the customer information gathering system according to claim 48, said backup means comprising means for holding said commodity information stored in said commodity information storing means.

55. The customer information gathering system according to claim 40, wherein said information gathering system includes means for providing said commodity for trial purchase at no charge.

56. A selling system, connected to a plurality of terminals through a network and held by a company, organization or the like providing a commodity in response to an order from said plurality of terminals, for providing a commodity for trial purchase for allowing users of said terminals to experience a purchase procedure of said commodity to a destination designated on said terminal, said selling system comprising means for displaying information on said commodity for trial purchase on said terminal and making an order to provide said commodity for trial purchase to said destination designated on said terminal when said commodity is specified on said terminal.

57. The selling system according to claim 56, further comprising means for providing said commodity for trial purchase at no charge.

58. Backup means comprising means for holding functions of said selling system according to claim 56 and information accumulated in said selling system.

59. Backup means comprising means for holding functions of said selling system according to claim 57 and information accumulated in said selling system.
